(19) United States
(12) Patent Application Publication
(10) Pub. No.: US 2006/0060345 A1
(43) Pub. Date: Mar. 23, 2006

(54) Cooling circuit, especially for a motor vehicle transmission

(75) Inventors: Markus Flik, Gerlingen (DE); Andreas Thumm, Ilsfeld (DE)

Correspondence Address: FOLEY AND LARDNER LLP;SUITE 500, 3000 K STREET NW, WASHINGTON, DC, 20007, US

(73) Assignee: BEHR GMBH & CO. KG, Stuttgart (DE)

(21) Appl. No.: 10/542,368

(22) PCT Filed: Jan. 14, 2004
(86) PCT No.: PCT/EP04/00204

§ 371 Date: Jul. 14, 2005

(30) Foreign Application Priority Data
Jan. 15, 2003 (DE) 103 01 314.8

(51) Int. Cl. B60H 1/00; G05D 23/00

(52) U.S. Cl. 165/297; 165/202

(57) ABSTRACT

The invention relates to a cooling circuit (2), especially for a motor vehicle transmission, comprising at least one heat exchanger (4, 5). According to the invention, two heat exchangers (4, 5) are serially connected. A first heat exchanger (4) causes heat to be conveyed from a first (10) to a second fluid (1, 3) while a second heat exchanger causes heat to be conveyed from the first (10) in a third fluid (9).

The invention relates to a cooling circuit, in particular for a motor vehicle transmission, according to the preamble of claim 1 and an associated operating method.

Conventional motor vehicle transmissions normally have a cooling circuit in which the heat of a first fluid, for example oil, is transferred to a second fluid, for example a coolant of an engine cooling circuit, in a heat exchanger.

In this arrangement, the temperature of the coolant of the engine cooling circuit is increased by the heat exchanger. In particular in transmissions which have a large amount of waste heat, for example CVTs, this could lead to problems since the engine cooling systems would then have to be appropriately adapted in order to be able to conduct away the additional heat.

The invention is based on the object of specifying a cooling circuit, in particular for a motor vehicle transmission, and an associated cooling method. The cooling circuit according to the invention and the associated method are intended to permit effective cooling, in particular of a vehicle transmission, without excessively increasing the temperature of a second fluid, for example the coolant of the engine cooling circuit.

This object is achieved according to the invention by means of a cooling circuit having the features of patent claim 1, and in relation to the method having the features of patent claim 10.

The dependent patent claims relate to advantageous embodiments and developments of the invention.

A main idea of the invention is to connect two heat exchangers is series in a cooling circuit, in particular for a motor vehicle transmission, wherein the two heat exchangers transmit the heat from a first fluid to a second or third fluid. In one particularly advantageous embodiment, the first fluid is a gear oil which, in a first heat exchanger, gives up its heat to a second fluid, for example a coolant, in particular to the coolant of an engine cooling circuit, and in a second heat exchanger gives up its heat to a third fluid, for example to air, which is conducted through the second heat exchanger.

The use of the second heat exchanger ensures that the temperature of the second fluid does not rise excessively, in particular if the second heat exchanger is configured in such a way that the greater part of the waste heat from the first fluid can be transferred to the third fluid. In particular, the entire waste heat from the first fluid can be transferred to the third fluid.

In one particularly advantageous embodiment, there is a bypass line in the cooling circuit with which the first or the second heat exchanger can be bypassed. In conjunction with a valve which is arranged between the first heat exchanger and the second heat exchanger and/or in the bypass line there is then the possibility of easily performing open-loop or closed-loop control of the temperature of the first fluid taking into account the temperature of the second fluid. Of course it is also possible to include other variables in the control of the valve, for example the temperature of the third fluid. The valve opens or closes as a function of the temperature and the arrangement. If the valve is arranged in the bypass line, the throughflow decreases as the temperature rises. If the valve is arranged between the two heat exchangers, the throughflow increases as the temperature rises. As an alternative it is also possible to use a proportional valve, which permits the flow of the first fluid through the second heat exchanger to be varied.

The at least one valve may be embodied as a thermostat valve or a valve which is controlled by means of an expansion material, in particular a wax valve. In addition it is possible to use an electronically controllable valve.

When the coolant circuit is used for a vehicle transmission, the first heat exchanger which is embodied as an oil/coolant heat exchanger may be arranged inside a coolant/air heat exchanger of the associated engine cooling circuit, in particular inside a water box of the coolant/air heat exchanger.

The main idea of the method according to the invention for cooling a heat-generating component is to provide two different operating modes, wherein in a first operating mode only the first heat exchanger is operated, and in a second operating mode the first and the second heat exchanger are operated, and wherein the two heat exchangers transmit the heat of the first fluid to different fluids. Switching over between the operating modes is carried out as a function of predefinable temperature threshold values, wherein the temperatures of all the fluids can be taken into account in a switching over process. The switching over may be carried out, for example, by means of one or more valves which are arranged in the circuit.

In addition it is possible to provide that the second heat exchanger is not connected entirely into the circuit or bypassed but instead the corresponding control means (valves) have any desired intermediate settings which are dependent, in particular, on a current temperature of the first fluid and/or of the second fluid and/or of the third fluid so that the first fluid flows only partially through the second heat exchanger and is partially directed past the second heat exchanger by a bypass line.

In one preferred embodiment, the first fluid is a gear oil, the second fluid is a coolant, in particular the coolant of an engine cooling circuit, and the third fluid is air, wherein the first operating mode is an idling operating mode and the second operating mode is, in particular, a normal operating mode, a partial operating mode or a full load operating mode of the vehicle transmission.

Exemplary embodiments of the invention are explained in more detail below with reference to the drawings.

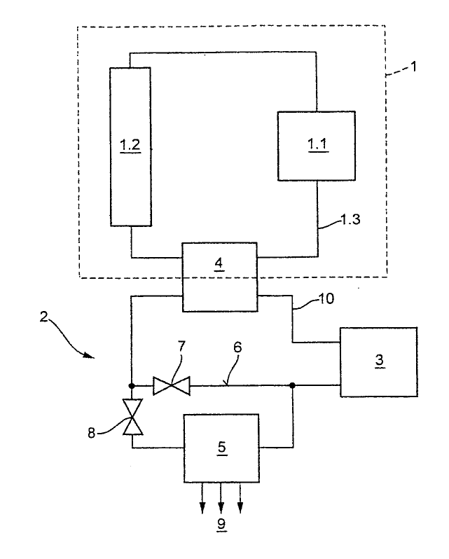

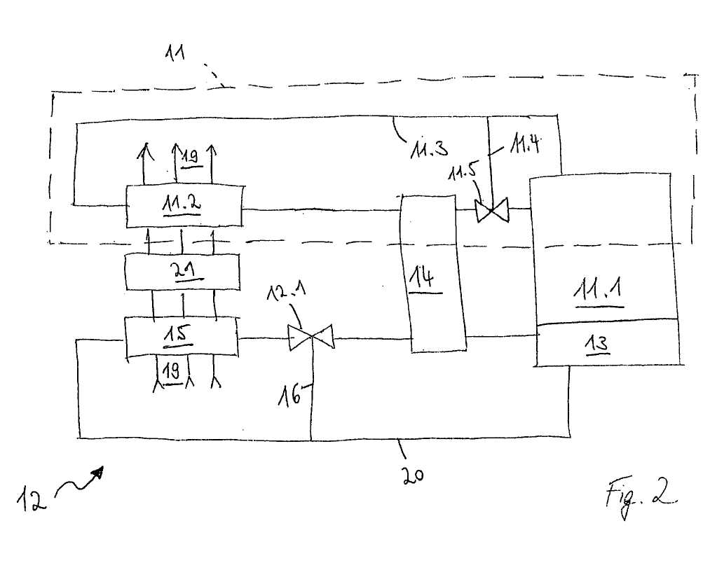

FIGS. 1 and 2 each show a schematic illustration of a cooling circuit according to the invention.

As is apparent from FIG. 1, a cooling circuit 2 according to the invention comprises a component 3 to be cooled, for example a vehicle transmission, a first heat exchanger 4, for example an oil/coolant heat exchanger which transfers the heat from a first fluid 10 flowing in the circuit to a second fluid 1.3, wherein the second fluid 1.3 is, for example, a coolant which is used in a different cooling circuit 1 for cooling a different component 1.1, for example a vehicle engine, by means of a further heat exchanger 1.2, for example a coolant/air heat exchanger (radiator).

The cooling circuit 2 also comprises a second heat exchanger 5 which transfers the heat of the first fluid 10 to a third fluid 9, for example to air which is directed through the second heat exchanger 5. The second heat exchanger can be bypassed by a bypass line 6 as a function of settings of the two valves 7, 8, or, as already stated, the first fluid 10 may flow through it partially or completely. The portion of the throughflow depends on the operating mode in which the cooling circuit 2 is operated and on the current temperature of one or more of the fluids 1.3, 9, 10, but at least on the temperature of the first fluid 10. Although the illustrated exemplary embodiment shows two valves 7, 8 for controlling the cooling circuit 2, it is possible to implement the control system just with the valve 7 in the bypass line 6 or just with the valve 8 upstream of the second heat exchanger 5.

FIG. 2 illustrates a further cooling circuit 12 which a component 13 to be cooled, for example a transmission which interacts with a vehicle engine 11.1, a first heat exchanger 14, for example an oil/coolant heat exchanger which transfers the heat from a first fluid 10 flowing in the circuit to a second fluid 11.3, wherein the second fluid 11.3 is, for example, a coolant which is used in another cooling circuit 11 for cooling another component 11.1, for example a vehicle engine, for example by means of a further heat exchanger 11.2, for example a coolant/air heat exchanger (radiator). In order to obtain a space-saving design, the heat exchanger 14 is preferably arranged within a collecting box or distribution box of the heat exchanger 11.2.

A bypass line 11.4 is used for bringing about a bypassing of the heat exchangers 11.2 and 14, which may be desired, by means of a first thermostat valve 11.5 which, for example, opens the bypass line up to a predefined temperature of the coolant in order to bring about more rapid heating of the vehicle engine 11.1.

The second heat exchanger may be bypassed by a bypass line 16 as a function of settings of a thermostat valve 12.1, or, as already stated, the first fluid 20 may flow through it partially or completely. The portion of throughflow depends on the operating mode in which the cooling circuit 12 is operated and on the current temperature of one or more of the fluids 11.3, 19, 20, but at least on the temperature of the first fluid 20.

The cooling circuit 12 also comprises a second heat exchanger 15 which transfers the heat of the first fluid 20 to a third fluid 19, for example to air which is conducted through the second heat exchanger 15, as appropriate by means of a further heat exchanger 21 such as, for example, a condenser of an air conditioning system, and through the heat exchanger 11.2.

The second heat exchanger may be bypassed by a bypass line 16 as a function of settings of a second thermostat valve 12.1 or, as already stated, the first flow 20 may flow through it partially or completely. The portion of throughflow depends on the operating mode in which the cooling circuit 12 is operated and on the current temperature of one or more of the fluids 11.3, 19, 20, but at least on the temperature of the first fluid 20. Since the heat exchanger 15 preheats, if appropriate, the cooling air 19, for the heat exchanger 11.2 and the condenser 21, which, under certain circumstances, adversely affects their efficiency, it is desirable to apply hot fluid 20 to the heat exchanger 15 as rarely as possible. For this reason, the second thermostat valve 12.1 preferably opens the bypass line to a predefined limiting temperature so that the heat exchanger 15 is operated only if the cooling of the fluid 20 by the heat exchanger 14 is insufficient or is at least to be supplemented.

1. A cooling circuit (2) in particular for a motor vehicle transmission, having at least one heat exchanger (4, 5), characterized in that two heat exchangers (4, 5) are arranged in series, wherein a first heat exchanger (4) causes heat to be transferred from a first fluid (10) to a second fluid (1.3), and wherein a second heat exchanger (5) causes heat to be transferred from the first fluid (10) to a third fluid (9).

2. A cooling circuit as claimed in claim 1, characterized in that the first heat exchanger (4) or the second heat exchanger (5) can be bypassed by a bypass line (6).

3. The cooling circuit as claimed in claim 1, characterized in that at least one valve (7, 8), in particular a thermostat valve (12.1) is provided, wherein a valve (8) is arranged between the first heat exchanger (4) and the second heat exchanger (5) and/or a valve (8) is arranged in the bypass line (6).

4. The cooling circuit as claimed in claim 3, characterized in that the at least one valve (7, 8) opens or closes as a function of a temperature of the first and/or of the second and/or of the third fluid (10, 1.3, 9).

5. The cooling circuit as claimed in claim 4, characterized in that the throughflow is reduced as the temperature of the fluid rises if the valve (7) is arranged in the bypass line (6), and the throughflow is increased as the temperature of the fluid rises if the valve (8) is arranged between the two heat exchangers (4, 5).

6. The cooling circuit as claimed in claim 3, characterized in that the at least one valve (7, 8) is a thermostat valve or a valve which is controlled by means of an expansion material, in particular a wax valve.

7. The cooling circuit as claimed in claim 1, characterized in that the first heat exchanger (4) is an oil/coolant heat exchanger, and wherein the second heat exchanger (5) is an oil/air heat exchanger.

8. The cooling circuit as claimed in claim 7, characterized in that the oil/coolant heat exchanger (4) is arranged inside a coolant/air heat exchanger (1.2) of an engine cooling circuit.

9. The cooling circuit as claimed in claim 8, wherein the oil/coolant heat exchanger (4) is arranged inside a water box of the coolant/air heat exchanger (1.2).

10. A method for cooling a heat-generating component (3), in particular of a motor vehicle transmission, characterized in that, in a first operating mode, a first heat exchanger (4) transmits heat from a first fluid (10) to a second fluid (1.3), and if a temperature of the first fluid (10) and/or of the second fluid (1.3) and/or of a third fluid (9) reaches and/or exceeds a predefinable first temperature threshold value in the first operating mode, the cooling circuit switches into a second operating mode, in that in the second operating mode an additional second heat exchanger (5), which transmits heat from the first fluid (10) to the third fluid (9), is connected into the circuit.

11. The method as claimed in claim 10, further characterized in that if the first fluid (10) and/or the second fluid (1.3) and/or the third fluid (9) reaches and/or drops below a predefinable second temperature threshold value in the second operating mode, the cooling circuit is switched over from the second operating mode into the first operating mode.

12. The method as claimed in claim 10, further characterized in that the processes of switching over between the operating modes are carried out by means of at least one valve (7, 8) which is arranged in the circuit (2) of the first fluid (10), wherein the second heat exchanger (5) is bypassed by means of a bypass (6) or is connected into the circuit (2) of the first fluid (10) by the at least one valve (7, 8) as a function of the temperature of the first fluid (10) and/or of the second fluid (1.3) and/or of the third fluid (9).

13. The method as claimed in claim 12, further characterized in that in the second operating mode the at least one valve (7, 8) assumes any desired intermediate settings in which the first fluid (10) only partially flows through the second heat exchanger (5).

14. The method as claimed in claim 10, characterized in that the first fluid (10) is a gear oil, the second fluid (1.3) is a coolant, in particular the coolant of an engine cooling circuit (1.3), and the third fluid (9) is air.

15. The method as claimed in claim 10, characterized in that the first operating mode is an idling operating mode of the component (3) to be cooled.

16. The method as claimed in claim 10, characterized in that the second operating mode is a normal operating mode or a full load operating mode of the component (3) to be cooled.
